(19) United States
(12) Patent Application Publication
(10) Pub. No.: US 2011/0100762 A1
(43) Pub. Date: May 5, 2011

(54) METHOD OF USING AN ELEVATOR SYSTEM, ELEVATOR SYSTEM FOR SUCH A METHOD AND METHOD OF RETROFITTING SUCH AN ELEVATOR SYSTEM AND ELECTRONIC DOOR TRIM

(75) Inventors: Bernhard Gerstenkorn, Luzern (CH); Kilian Schuster, Emmenbrucke (CH); Paul Friedli, Remetschwil (CH); Manfred Klostermeier, Durchhausen (DE); Jurgen Vosseler, Durchhausen (DE)

(73) Assignees: INVENTIO AG, Hergiswil (CH); INGERSOLL RAND SECURITY TECHNOLOGIES, Carmel, IN (US); INTERFLEX DATENSYSTEME GMBH & CO. KG, Durchhausen (DE)

(21) Appl. No.: 12/990,165

(22) PCT Filed: Apr. 28, 2009
(86) PCT No.: PCT/CH2009/000135

§ 371 Date: Jan. 5, 2011

(30) Foreign Application Priority Data
Apr. 28, 2008 (EP) PCT/EP2008/055193
Oct. 6, 2008 (DE) 10 2008 050 563.3

(51) Int. Cl. B66B 13/14; E05B 65/08; E05B 47/00

(52) U.S. Cl. 187/384; 70/95

(57) ABSTRACT

The invention relates to a method of operating an elevator system in a building with at least two storeys (1, 1′, 1″), at least one elevator door (3, 3′, 3′) and at least one building door (2, 2′, 2″). Through opening and/or closing of a building door (2, 2′, 2″) the storey (1, 1′, 1″) of the opened and/or closed building door (2, 2′, 2″) is defined as stan storey and a destination call for an elevator cage (7) to the start storey is actuated: As soon as the elevator cage (7) has reached the start storey the elevator door (3, 3′, 3″) of the start storey is opened. As soon as at least one user has entered the elevator cage (7) the opened elevator door (3, 3′, 3″) is closed and the user is moved by the elevator cage (7) to a destination storey.

The invention relates to a method of using an elevator system, to an elevator system for such a method and to a method of retrofitting such an elevator system, according to the introductions of the independent claims. The invention also pertains to an electronic door trim.

A control device for an elevator is known from EP0832838A1, which makes it possible for a house occupant to provide for a visitor, immediately on opening the house door, an elevator cage which moves the visitor exactly to the correct storey of the house occupant without either of the house occupant or the visitor having to actuate a button for use of the elevator.

An object of the present invention is to further develop this method for use of an elevator.

In addition, electronic door trims are used, amongst others, in conjunction with,access-control systems, and they are regularly combined with components of architectural hardware, door locks, door closers, door frames and doors in general. Electronic door trims are for example used for monitoring and controlling the access of authorized or non-authorized people to security sensitive areas.

Such electronic door trims are for example known under the trademarks and/or type designations PEGASYS and 6020 System, which are manufactured and sold by the applicant. Details of this known system are described in the User Manual “Pegasys Offline Terminals and the 6020 System, Version 1.56”, issued by the applicant dated Jan. 25, 2006.

These electronic door trim systems control the unlocking and opening or blocking, respectively, of a door or a similar device for an authorized or non-authorized access. Therein, the electronic door trim systems are for example controlled and activated by the use of an electronic chip card, by the entry of a specific code over a keyboard, or similar devices. Further, electronic door trim systems comprise a battery driven electronic control unit that monitors and controls, amongst others, the status of contacts, and that activates and engages or disengages, respectively, levers and bolts by a coupling or clutch within the lock. For the operation of these components, such systems generally require extensive and complex wiring with cables which has to be integrated with the associated contacts into the lock and/or the door and/or the door frame. The wiring is particularly also required for the data transfer and the communication between the individual components of the control system. Thus, these systems are regarded as being offline devices.

A problem underlying such known electronic door trim systems is the secure and reliable operation of the systems, as said complex wiring may tend to have defects and errors, which may in turn result in a partial or complete failure of the overall system.

These objects are fulfilled by the invention in accordance with the definition of the independent claims. Therefore, it is an aim of the invention to overcome these problems and to provide an improved electronic door trim system.

In the method of operating an elevator system according to claim 1 a building has at least two storeys, at least one elevator door and at least one building door. Through opening and/or closing a building door the storey of the opened building door is defined as start storey. A start call for an elevator cage to the start storey is actuated. As soon as the elevator cage has reached the start storey the elevator door of the start storey is opened.

In the elevator system according to claim 4 a building has at least two storeys, at least one elevator door and at least one building door. The building door has at least one door sensor. The door sensor detects opening and/or closing of a building door and communicates, for a detected opening and/or closing of the building door, at least one door signal to at least one elevator control. The elevator control defines the storey of the communicated door signal as start storey and actuates a start call for an elevator cage to the start storey. At least one elevator sensor detects movement of the elevator cage into the start storey. The elevator sensor communicates, for a detected movement of the elevator cage into the start storey, at least one elevator cage signal to the elevator control. On communication of an elevator cage signal the elevator control opens the elevator door of the start storey.

This has the advantage that a user does not have to actuate a start call for an elevator cage. As soon as the user by opening and/or closing a building door gives recognition to his or her wish to use the elevator system the start call is automatically actuated for the user and the elevator door automatically opened for the user.

The building door is advantageously an access door to a dwelling in the building and/or an access door to the building.

This has the further advantage that the user does not have to actuate a start call for an elevator cage either on entering the building or on leaving the building.

Advantageously the start storey is defined only when the building door is opened from a side remote from the elevator door and/or when the building door is closed from a side remote from the elevator door.

This is of advantage because it is ensured that a user on opening and/or closing the building door actually moves to an elevator door.

Advantageously the door sensor is an electromechanical contact of the building door; and the electromechanical contact communicates a detention of a deadbolt in a lock plate and/or a release of a deadbolt from a lock plate as door signal to the elevator control. Advantageously the door sensor is a credential reader of the building door; and the credential reader communicates a detection of a credential as door signal to the elevator control. Advantageously the door sensor is a lock bolt sensor; and the lock bolt sensor communicates a status of a deadbolt of the building door as door signal to the elevator control. Advantageously the door sensor is an override sensor; and the override sensor communicates a status of a mechanical key overide of the building door as door signal to the elevator control. Advantageously the door sensor is a clutching mechanism for an inside lever and an outside lever of the building door; and the clutching mechanism communicates a movement of the inside and/or outside lever as door signal to the elevator control. Advantageously the door sensor is an infrared reflective photo sensor; and the infrared reflective photo sensor communicates detection of a user in front of the building door as door signal to the elevator control. Advantageously the door sensor is a command button on the inner and/or outer side of the building door; and the command button communicates activation of the command button as door signal to the elevator control.

This is of advantange because a plurality of different sensors may be used for detecting the opening and/or closing of a building door.

Advantageously a destination call for the elevator cage to a destination storey is actuated. In that case advantageously either a pre-defined destination call filed for a start storey is actuated by the elevator control or advantageously the user is identified by at least one recognition device and a pre-defined destination call filed for an identified user is actuated by the elevator control. For this purpose the recognition device advantageously communicates, for an identified user, at least one user recognition signal to the elevator control. The elevator control actuates a pre-defined destination call, which is filed for the communicated user recognition signal, for the elevator cage to a destination storey.

This has the particular advantage that the user does not have to actuate either a start call or a destination call. This saves time, since the user does not have to stop his or her movement during entry into or departure from the building in order to actuate an input keyboard for a destination call. Such stopping of movement is tiresome and involves effort particularly for users carrying bags or luggage with both hands.

Advantageously the destination call is actuated by the user by at least one call input device. Advantageously the call input device is arranged in stationary position near an elevator door and/or to be mobile with the user.

This is of advantage, since the user then has the freedom to actuate a destination call either by a stationary call input device in stationary position near an elevator door and/or by a mobile call input device which the user carries as an item of everyday life.

Advantageously the destination call is contactlessly actuated by the user.

This has the further advantage that a contactless actuation of the destination call is hygienic. This is a recognised user requirement for hygienic transport particularly in large buildings with a high incidence of user traffic.

Advantageously the filed pre-defined destination call is changed by the user by at least one call input device and the destination call changed by the user is actuated. In that case the destination call is advantageously changed and actuated by the user contactlessly.

This has the additional advantage that the user then has the possibility of making situational adaptation of a filed pre-defined destination call. Thus, for a start storey at the 10th storey of a building a destination storey can be filed in pre-defined manner at the ground floor of the building. Such an allocation corresponds with the standard case according to which the user in the morning takes the elevator from his or her dwelling in the start storey to the destination storey at the ground floor in order to leave the building. If, however, the user now wants to travel by the elevator from his or her dwelling to the 20th storey in order to enjoy an attractive view in an evening he or she can temporarily change the destination storey.

Advantageously the opened elevator door is closed as soon as at least one user has entered the elevator cage and the user is moved by the elevator cage to a destination storey. For this purpose at least one cage sensor detects entry of the elevator cage by at least one user. The cage sensor communicates, for a detected entry of the elevator cage by the user, at least one elevator cage use signal to the elevator control. The elevator control on communication of an elevator cage use signal closes the opened elevator door.

This is of substantial advantage because, since the elevator door is closed immediately after entry of the elevator cage, the user can be moved upwardly and smoothly to the destination storey.

In the method of retrofitting an elevator system in accordance with claim 12 a building has at least two storeys, at least one elevator cage and at least one building door. It further has at least one elevator cage, at least one elevator control and at least one elevator sensor. At least one door sensor is installed in at least one building door. At least one control is installed. The opening and/or closing of the building door is detected by the door sensor. For a detected opening and/or closing of the building door at least one door signal is communicated to the control by the door sensor. The storey of the communicated door signal is defined as part storey by the control. A start call for the elevator cage to the start storey is actuated by the control. Movement of the elevator cage into the start storey is detected by the elevator sensor. For a detected movement of the elevator cage into the start storey at least one elevator cage signal is communicated to the elevator control by the elevator sensor. The elevator door of the start storey is opened by the elevator control on communication of an elevator cage signal.

This has the advantage that an existing elevator can be retrofitted in simple manner with a door sensor and a control for the door sensor in order to make possible for a user, through opening and/or closing of a building door, automatic actuation of a start call for him or her and automatic opening of the elevator door.

Advantageously a pre-defined destination storey, which is filed for the start storey, for the elevator cage to a destination storey is actuated by the control. Advantageously at least one recognition device is installed in at least one existing building door and/or near at least one elevator door and/or in the elevator cage. Advantageously the user is identified by the recognition device. For an identified user at least one user recognition signal is communicated to the control by the recognition device. A pre-defined destination call, which is filed for the communicated user recognition signal, for the elevator cage is actuated on a destination storey by the control.

This has the advantage that the user,'even in the case of a retrofitted elevator system, does not have to actuate either a start call or a destination call.

The building door for use in the elevator system or in the method for installation of the elevator system comprises at least one door sensor which is integrated in the building door. Advantageously the building door has at least one recognition device which is integrated in the building door.

This has the advantage that the door sensor or the recognition device is dissimulated in the building door and thus is not perceived by the user.

Advantageously the door sensor or the recognition device is mounted near the building door.

This is of particular advantage because conventional building doors can then be used.

Advantageously the door sensor is an electromechanical contact of the building door; and the electromechanical contact communicates a detention of a deadbolt in a lock plate and/or a release of a deadbolt from a lock plate as door signal to an electronic controller of the building door. Advantageously the door sensor is a credential reader of the building door; and the credential reader communicates a detection of a credential as door signal to an electronic controller of the building door. Advantageously the door sensor is an override sensor; and the override sensor communicates a status of a mechanical key overide of the building door as door signal to an electronic controller of the building door. Advantageously the door sensor is an lock bolt sensor; and the lock bolt sensor communicates a status of a deadbolt of the building door as door signal to an electronic controller of the building door. Advantageously the door sensor is a clutching mechanism for an inside lever and an outside lever of the building door; and the clutching mechanism communicates a movement of the inside and/or outside lever as door signal to an electronic controller of the building door. Advantageously the door sensor is an infrared reflective photo sensor; and the infrared reflective photo sensor communicates detection of a user in front of the building door as door signal to an electronic controller of the building door. Advantageously the door sensor is a command button on the inner and/or outer side of the building door; and the command button communicates activation of the command button as door signal to an electronic controller of the building door.

This is of advantange because a plurality of different sensors may be used for detecting the opening and/or closing of a building door.

Advantageously the door sensor communicates at least one door signal to a wakeup circuit of the building door; the wakeup circuit collects the door signal as wakeup signal and communicates the wakeup signal to an electronic controller of the the building door; and the electronic controller wakes up for a received wakeup signal.

This is of advantange because a door sensor may inform a wakeup circuit about a detected opening and/or closing of a building door. Upon collection of a door signal, the wakeup circuits wakes up the electronic controller of the building door. When no door signal is collected by the wakeup circuit, the electronic controller may change to a sleep mode with low or even, zero energy consumption, thus increasing the energy autonomy of the battery powered building door.

Advantageously at least one antenna is installed. Advantageously the door sensor communicates at least one door signal by way of at least one radio network to the elevator control or the control and/or the recognition device communicates at least one user recognition system by way of at least one radio network to the elevator control or the control. Advantageously and/or the door sensor communicates at least one door signal to an electronic controller of the building door; the electronic controller communicates the door signal to a wireless communication unit of the building door; and the wireless communication unit communicates a door signal to the elevator control or the control by way of at least one radio network.

This has the advantage that the door sensor and/or the recognition device of the building door can communicate the door signal and/or the user recognition signal by radio network to the control or the elevator control. The laying of data cables of a fixed network is not necessary for that purpose.

The aim of the invention to provide an improved electronic door trim system is achieved by an electronic door trim according to claim 20. With such an electronic door trim, a lock is operating like an online door which supervises the lock bolt status contact, and is online connected to an access control system.

Particularly, according to the invention, an electronic door trim is equipped with a battery driven wireless connection on the base of a radio transmission technology (Funküber-tragungstechnik). The respective wireless communication units can be operated with various frequencies, wherein one known system is the wireless LAN technology as used for Internet access in private or public surroundings. Another wireless communication system, which is suitable for the embodiment of the invention, is a system sold under the trademark “ZigBee” (www.zigbee.org). This known system is particularly well suited for a battery driven operation, considering the limited life time of a battery. This system typically has a range of 30 to 100 Meters. However, also other, comparable systems may be used for the purposes of the invention.

The use of said wireless communication units offers the advantage that the door trims will no longer be offline, but get the capability to react online by the wireless connection to a host computer (as, e.g. in the PEGASYS system, the access control System IF 6020). The wireless communication systems (such as e.g. the “ZigBee” connection) typically put only 5% of additional load to the battery.

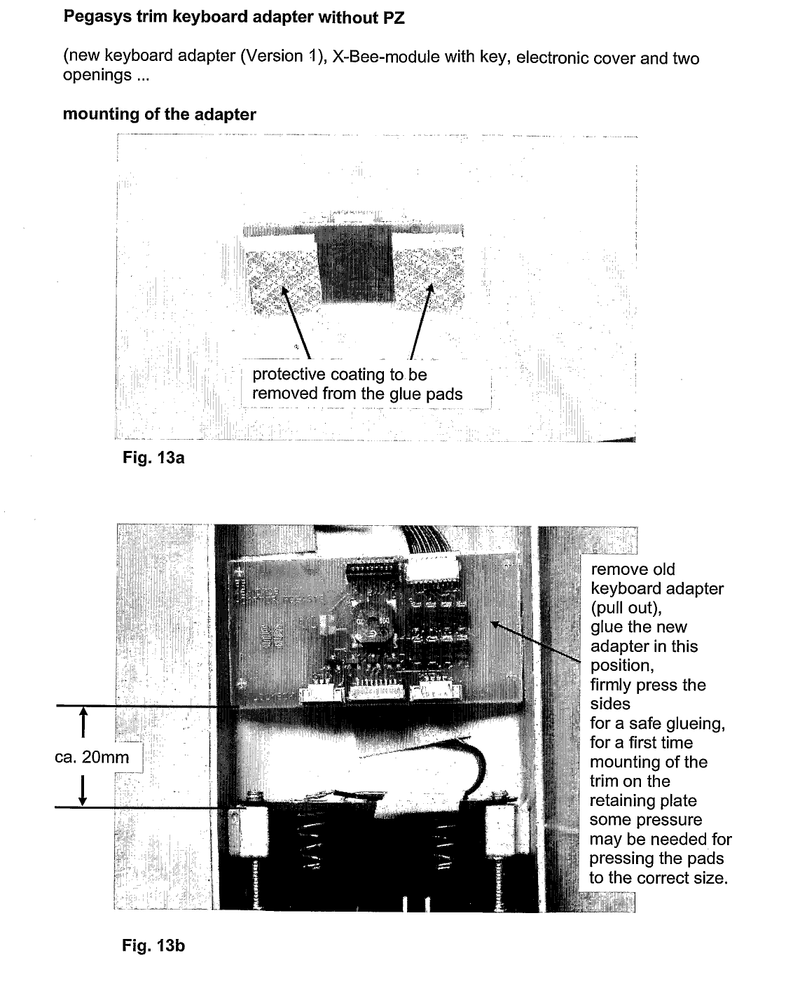

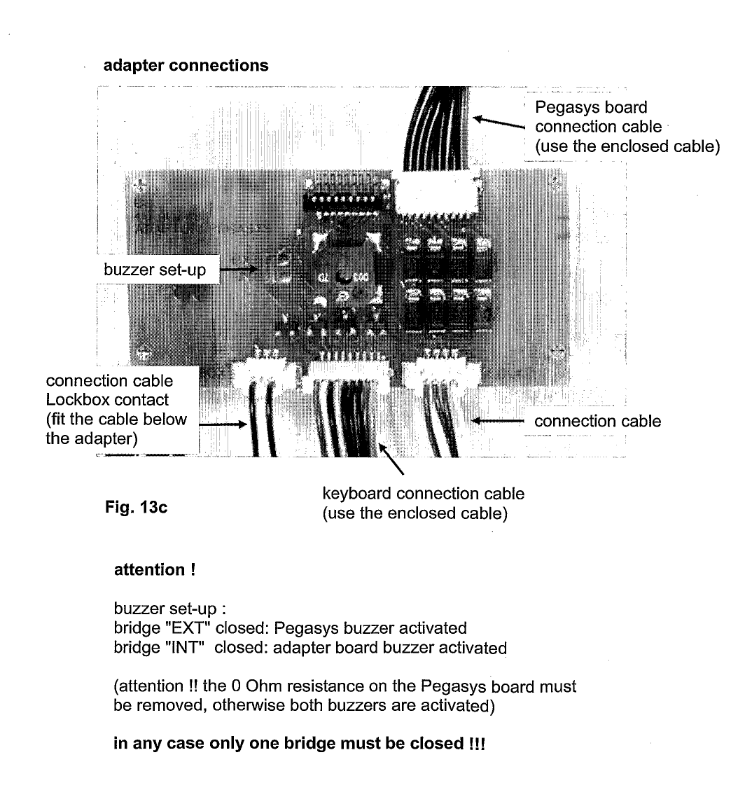

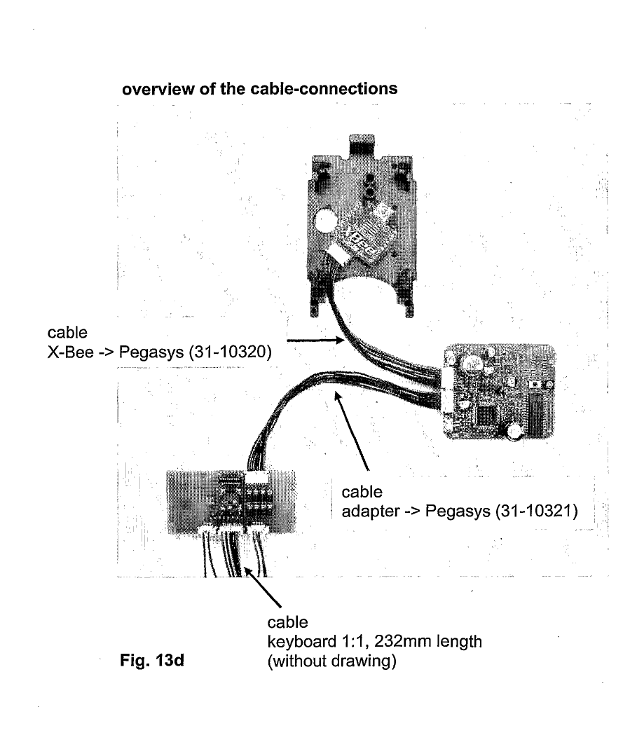

To allow the full door control, a mortise lock is added to the wireless connected electronic door trim. This offers status contacts for the lever handling from inside a room, a status of a mechanical override by a mechanical locking cylinder, and a status of the dead bolt. These status contacts are attached to the electronics of the electronic door trim by an adapter board (see FIGS. 13a to 13d, as further discussed below).

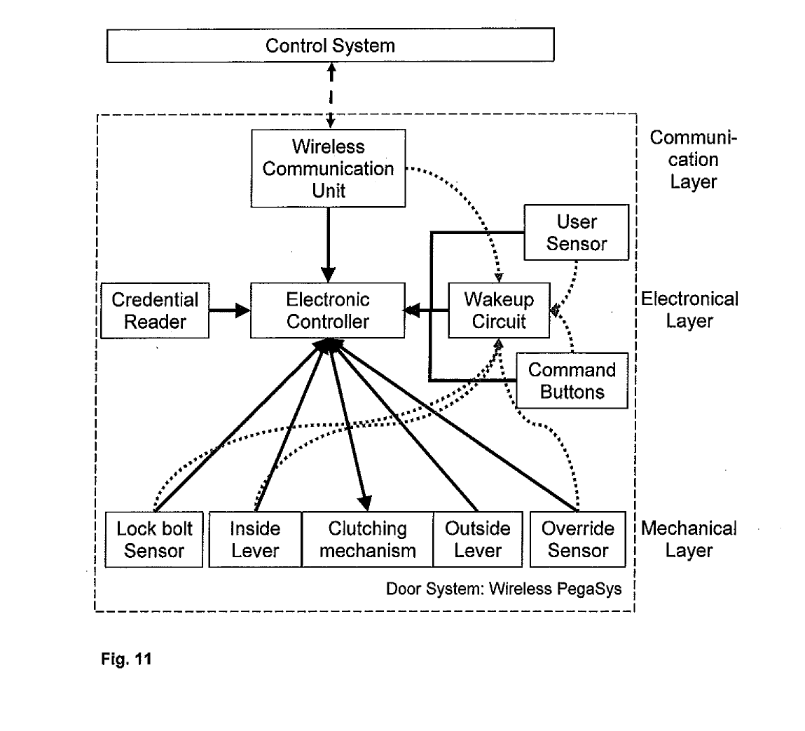

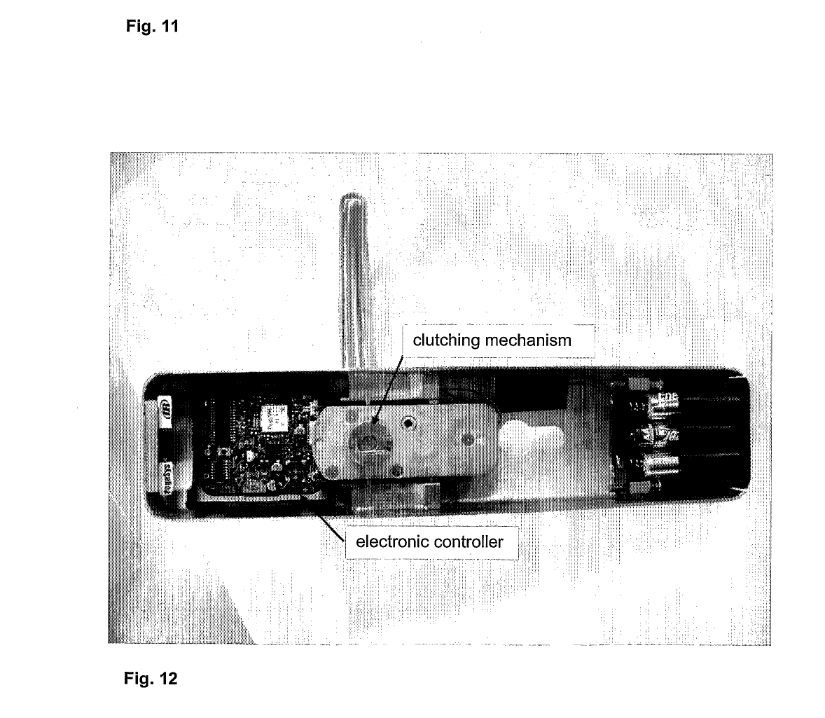

In an embodiment of the invention, for example, as said mortise lock a self locking lock with panic function can be utilized, as for example manufactured and sold by Cisa S.p.A. of Faenza, Italy. One embodiment of such mortise lock is shown in FIGS. 11 and 12. Therein, FIG. 12 shows the door trim from the backside, wherein for clarity purposes the version without wireless connection is shown here as a sample. Mortise locks known in the prior art generally comprise mechanical sensor means for monitoring and reporting the turning of a key, the position of the door lock bolts (extended or retracted), and the like.

Examples of embodiment of the invention are explained in more detail by way of the figures, for which purpose in partly schematic form:

FIG. 1 shows a partially sectioned view of a part of an elevator system in a building;

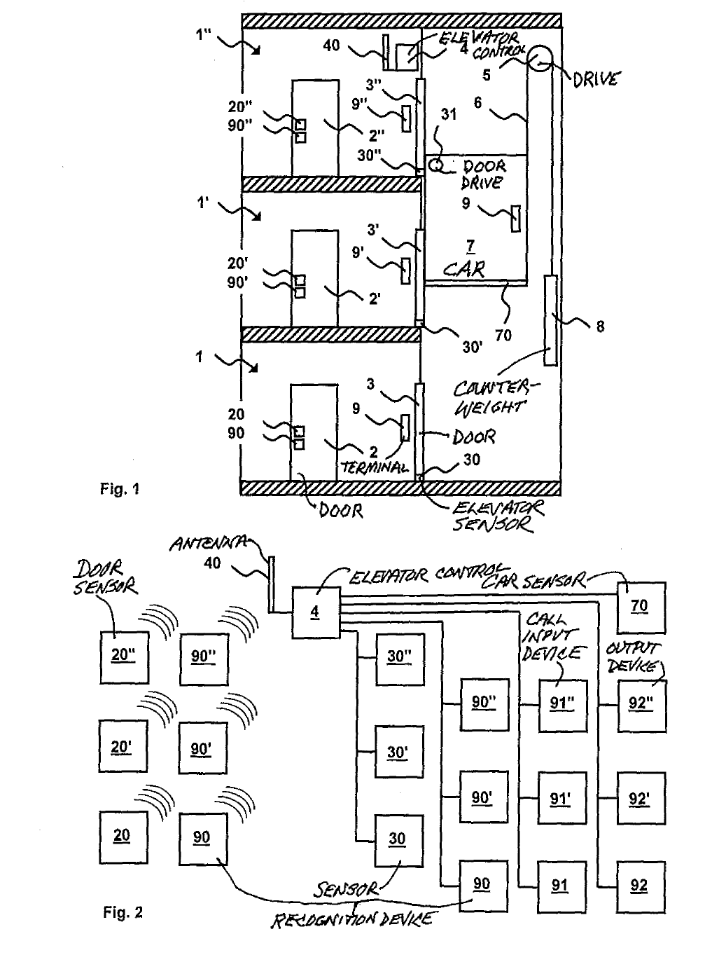

FIG. 2 shows a partially sectioned view of a part of a network of an elevator system according to FIG. 1;

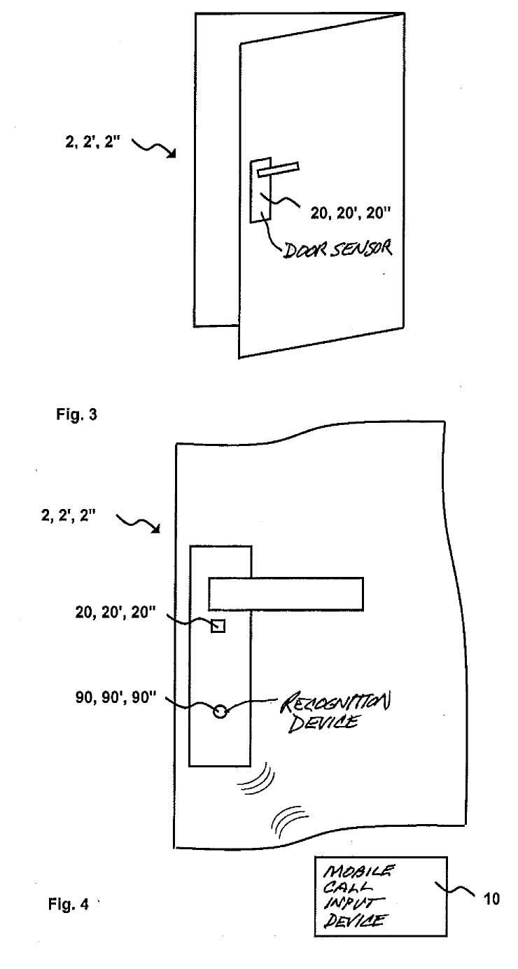

FIG. 3 shows a view of a part of a first form of embodiment of a building door with door sensor for the elevator system according to FIG. 1;

FIG. 4 shows a view of part of a second form of embodiment of a building door with door sensor for the elevator system according to FIG. 1;

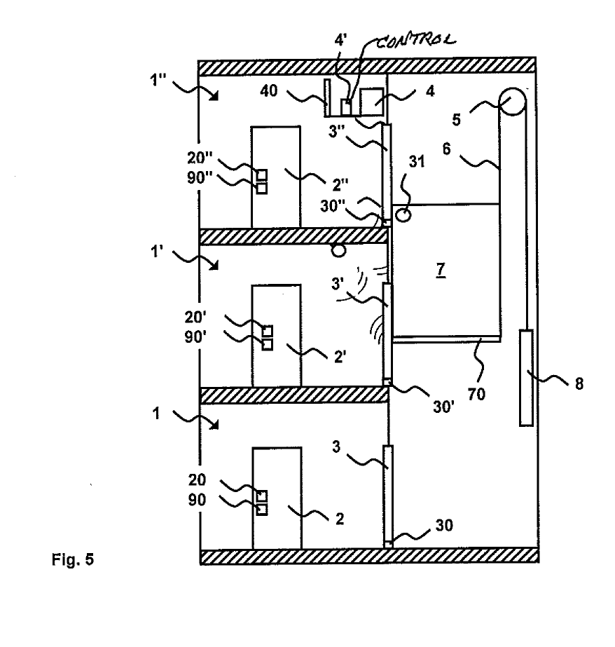

FIG. 5 shows a view of a part of a first form of embodiment of a terminal for the elevator system according to FIG. 1;

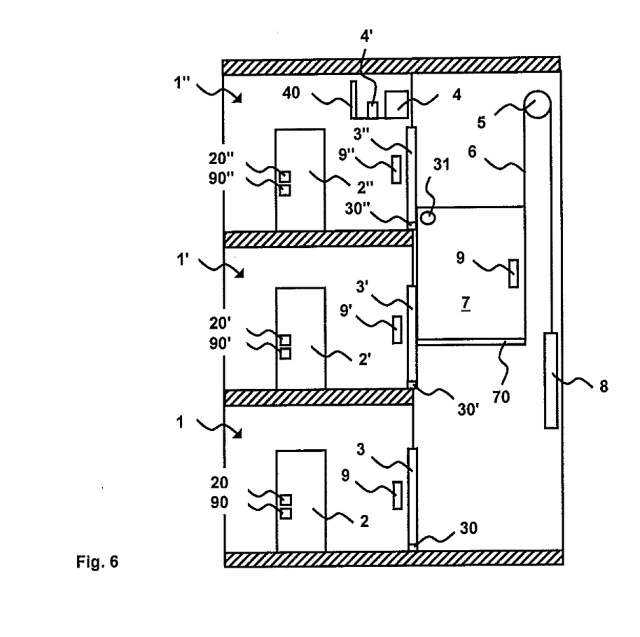

FIG. 6 shows a view of a part of a second form of embodiment of a terminal for the elevator system according to FIG. 1;

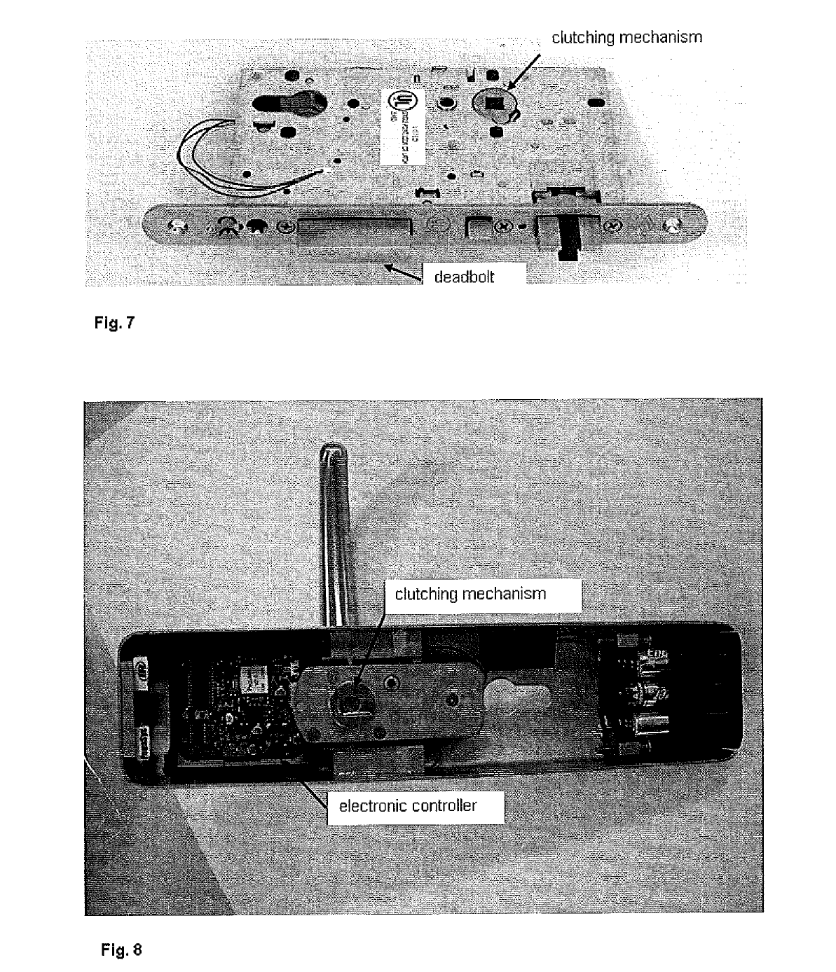

FIG. 7 shows a view of a part of a third form of embodiment of a terminal for the elevator system according to FIG. 1;

FIG. 8 shows a view of a part of a fourth form of embodiment of a terminal for the elevator system according to FIG. 1;

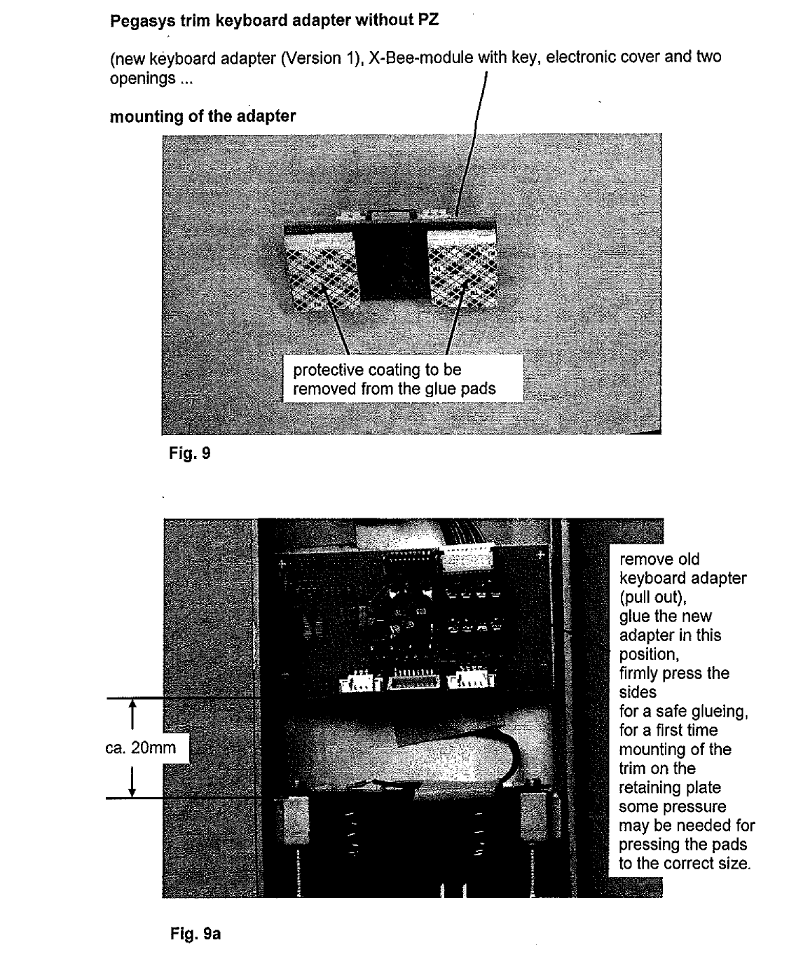

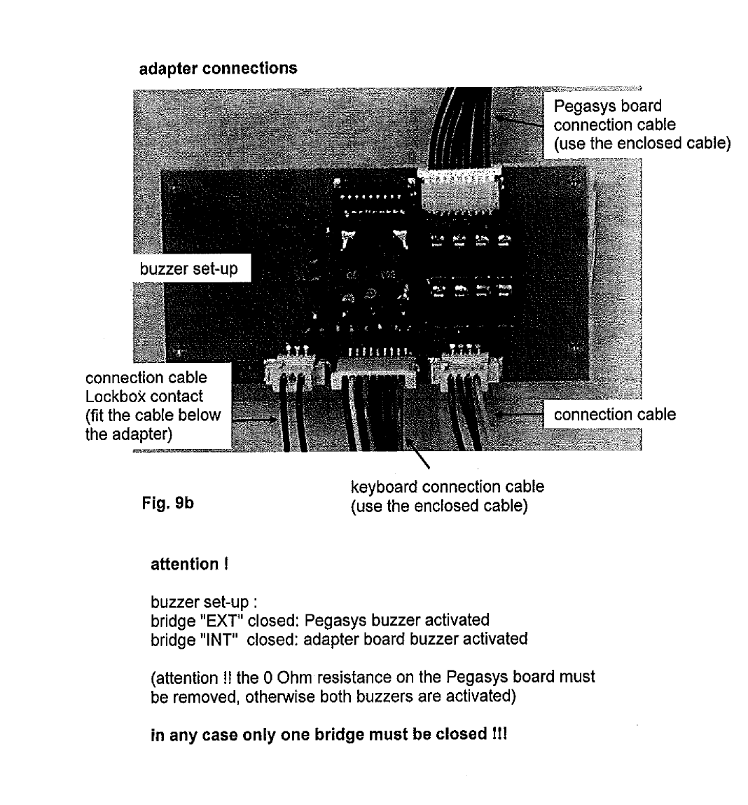

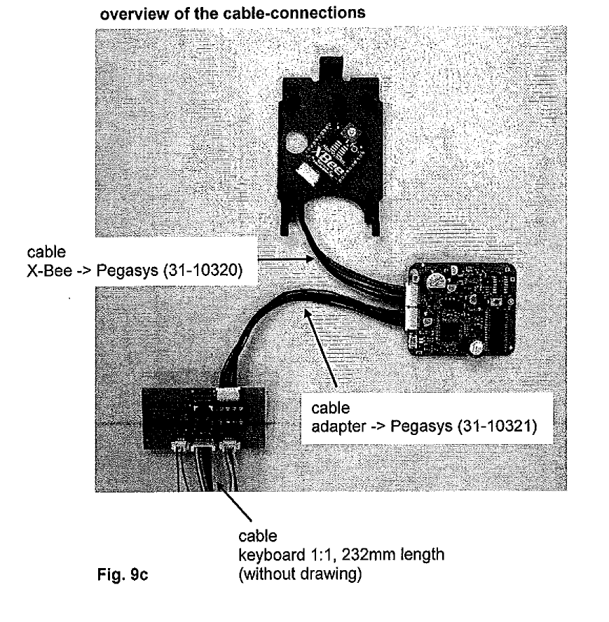

FIG. 9 shows a partially sectioned view of a part of a retrofitted elevator system in a building;

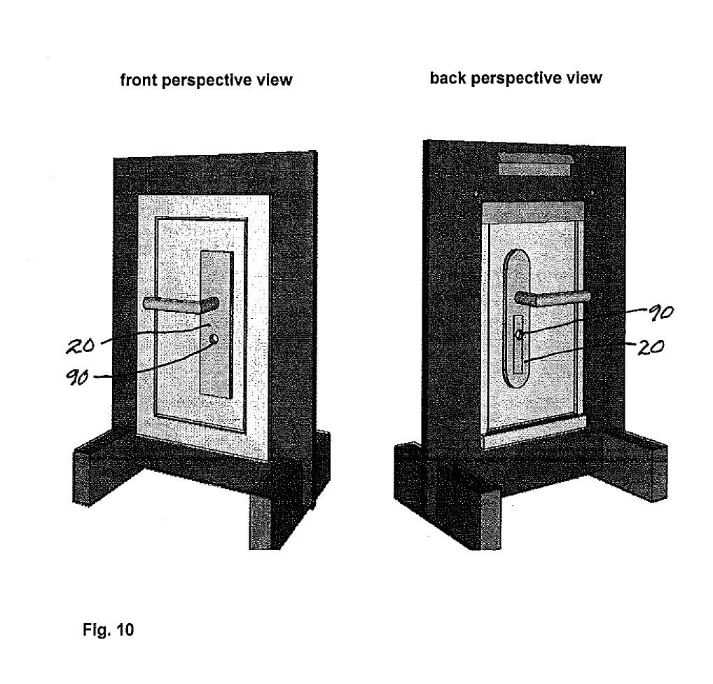

FIG. 10 shows a partially sectioned view of a part of a further retrofitted elevator system in a building according to FIG. 9;

FIGS. 11 and 12 show an embodiment of a mortise lock used in connection with the electronic door trim of the invention;

FIGS. 13a to 13d show the mounting of the wireless device according to the invention with an adapter to the door trim;

model within which the wireless functions according to the invention may be utilized; and

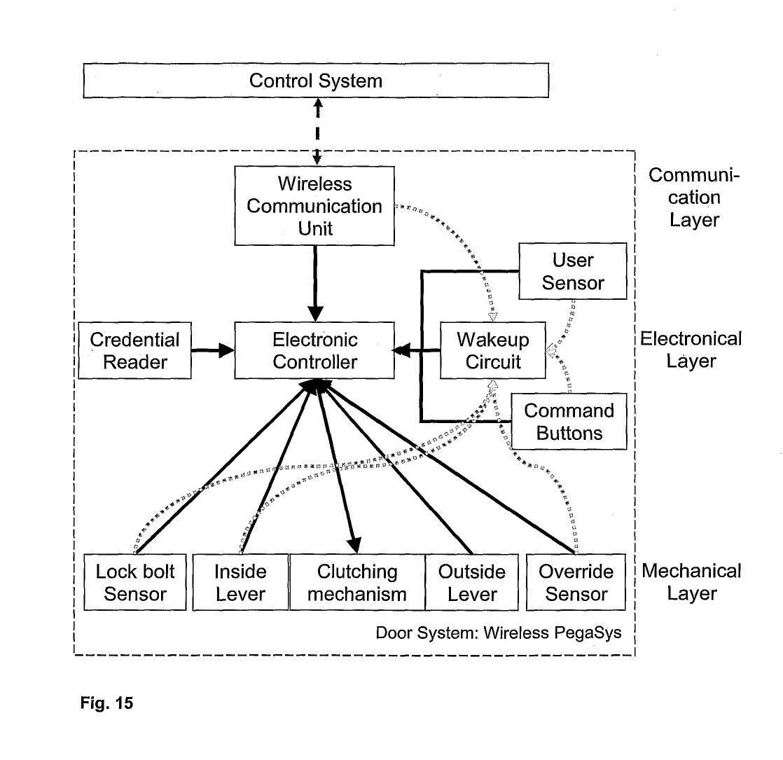

FIG. 15 is a block diagram showing the components of the electronic door trim according to the invention.

FIGS. 1 to 15 show examples of embodiment of the invention, wherein FIG. 1 shows an elevator system in a building, FIG. 2 shows a network of the elevator system, FIGS. 3 and 4 show two forms of embodiment of a building door with door sensor for the elevator system, FIGS. 5 to 8 show four forms of embodiment of a terminal for the elevator system and FIGS. 9 and 10 show a retrofitted elevator system in a building.

According to FIG. 1 the building has several storeys 1, 1′, 1″ and at least one building door 2′, 2″ giving access to at least one room. The building door 2, 2′, 2″ is an access door to a dwelling in the building and/or an access door to the building. An elevator system is arranged in the building. The elevator system has in an elevator shaft at least one elevator cage 7 which is connected with at least one counterweight 8 by way of at least one support means 6. For movement of elevator cage 7 and counterweight 8 the support means 6 is placed in motion by at least one elevator drive 5 in friction couple. At least one user has access to the elevator cage 7 by way of at least one elevator door 3, 3′, 3″. At least one elevator door 3, 3′, 3″ is usually arranged in each storey 1, 1′, 1″. With knowledge of the present invention the building can obviously have more than three storeys and the elevator system can have more than one elevator cage in an elevator shaft or also several elevator cages in several elevator shafts.

For safety reasons the elevator doors 3, 3′, 3″ of a storey 1, 1′, 1″ are opened only when an elevator cage 7 stands at this storey 1, 1′, 1″. The opening and closing of the elevator doors 3, 3′, 3″ takes place by way of at least one door drive 31, which is usually arranged at the elevator cage 7 and can be brought into operative connection with the elevator doors 3, 3′, 3″. At least one elevator control 4 controls the elevator drive 5 and the door drive 31. So that the elevator control 4 knows when an elevator cage 7 has moved into a storey 1, 1′, 1″, at least one elevator sensor 30, 30′, 30″ detects movement of the elevator cage 7 into the storey 1, 1′, 1″. The elevator sensor 30, 30′, 30″ communicates, for a detected movement of the elevator cage 7 into a storey 1, 1′, 1″, at least one elevator cage signal to the elevator control 4. The elevator control 4 on communication of an elevator cage signal opens the elevator door 3, 3′, 3″ of the storey 1, 1′, 1″. The elevator sensor 30, 30′, 30″ is arranged in the elevator shaft near the elevator doors 3, 3′, 3″ and consists of, for example, a mechanical or electrical contact which is actuated by the elevator cage 1 as soon as this is moved into a storey 1, 1′, 1″ to be flush with the storey floor.

The elevator cage 7 has at least one elevator sensor 7. This consists of, for example, a load mat which is mounted on the floor of the elevator cage 7 and in the case of weight loading by at least one user communicates an elevator cage use signal to the elevator control 4. Other forms of elevator sensors detecting use of the elevator cage, such as load sensors at the fastening of the support means, movement reporting devices in the elevator cage, etc., are obviously equally usable with knowledge of the present invention.

The elevator control 4 can be arranged at any desired location in the building. The elevator control 4 is usually arranged in the vicinity of the elevator drive 5; according to FIG. 1 the elevator control 4 is arranged on the uppermost storey 2″ in the vicinity of the elevator drive 5.

FIG. 2 shows a network of the elevator system. The elevator sensors 30, 30′, 30″ of the elevator shaft as well as recognition devices 90, 90′, 90″, call input devices 91, 91′, 91″ and output devices 92, 92′, 92″ of the terminal 9, 9′, 9″ as well as the cage sensor 70 of the cage 7 are connected with the elevator control 4 by way of a fixed network.

The building door 2, 2′, 2″ comprises an electronic door trim which will be described more in detail in the description of an embodiment of the invention in connection with the FIGS. 11 to 15. The building door 2, 2′, 2″ comprises a door leaf, a door frame and a doorstep. Opening and closing of the building door 2, 2′, 2″ means that the door leaf performs a relative movement with respect to the doorstep. An already minimal relative movement gives recognition to the user's wish to cross the doorstep.

Door sensors 20, 20′, 20″, an electronic controller of the building door 2, 2′, 2″ and recognition devices 90, 90′, 90″ of the building doors 2, 2′, 2″ are connected with an antenna 40 of the elevator control 4 by way of a radio network. Known radio networks are Wireless Local Area Network (WLAN) according to the Standard IEEE 802.11 and Worldwide Interoperability for Microwave Access (WIMAX) according to the Standard IEEE 802.16 with a range of several 100 metres up to 10 kilometres. The radio frequency used by the radio network is in the case of a WLAN, for example, in the 2.4 GHz band or in the 5.0 GHz band and in the case of WIMAX in the 10 to 66 GHz band. A particular wireless communication system sold under the trademark “ZigBee” will be described more in detail in the description of an embodiment of the invention in connection with the FIGS. 11 to 15. Not only the fixed network, but also the radio network allow a bidirectional communication according to known and proven network protocols such as the Transmission Control Protocol/Internet Protocol (TCP/IP) or Internet Packet Exchange (IPX). The fixed network comprises, for example, several electrical and/or optical data cables which are laid in the building, for example, under plaster or also suspended in the elevator shaft and thus connect the terminals 9, 9′, 9″ with the elevator control 4 as well as the elevator cage 7 with the elevator control 4. With knowledge of the present invention obviously also the elevator sensors 30, 30′, 30″ of the elevator shaft, the recognition devices 90, 90′, 90″, call input devices 91, 91′, 91″ and output devices 92, 92′, 92″ of the terminals 9, 9′, 9″ as well as the cage sensor of the elevator cage 7 can be connected with the elevator control 4 by way of a radio network.

First, the door signal communicates to the elevator control 4 the expression of the user wish to use the elevator system. A door signal is sufficient for this purpose. For example, a door signal is communicated to the elevator control 4 as soon as the building door 2, 2′, 2″ is opened even only to the extent of the gap. In order to ensure that the user not only opens the building door 2, 2′, 2″, but also goes through the door frame and closes the building door 2, 2′, 2″ again, a door signal is communicated to the elevator control 4 as soon as the building door 2, 2′, 2″ is reclosed. In order to further ensure that the user actually moves in the direction of an elevator door 3, 3′, 3″ a door signal is communicated only when a building door 2, 2′, 2″ is opened from a side remote from the elevator door 3, 3′, 3′' and/or when the building door 2, 2′, 2″ is closed from a side remote from the elevator door 3, 3′, 3″.

FIGS. 3 and 4 show two forms of embodiment of a building door 2, 2′, 2″ with door sensor 20, 20′, 20″ for the elevator system. The door sensor 20, 20′, 20″ is integrated in the building door 2, 2′, 2″ and/or electronic door trim. For example, the door sensor 20, 20′, 20″ is integrated in the door hardware and thus dissimulated to be imperceptible by users from the outside. The door hardware comprises a door pawl and a deadbolt. When the building door 2, 2′, 2″ is closed the deadbolt is detented in a lock plate of a door frame. Through movement of the door pawl the deadbolt is released from the lock plate of the door frame and the building door 2, 2′, 2″ is opened. The door sensor 20, 20′, 20″ detects the movement of the door pawl, for example by means of an electromechanical contact. In a first contact setting the deadbolt is detented in the lock plate and in a second contact setting the deadbolt is released from the lock plate. Opening of the building door 2, 2′, 2″ thus corresponds with movement of the door 4 from a first contact setting to a second contact setting. Closing of the building door 2, 2′, 2″ thus corresponds with movement of the door pawl from a second contact setting to a first contact setting. The door sensor 20, 20′, 20″ detects this opening or closing of the building door 2, 2′, 2″ and communicates at least one door signal to the elevator control 4. The electromechanical contact may be a magnet and a hall sensor. The magnet may be placed on the door pawl, the hall sensor may be placed next to the door pawl. It is also possible, to place the magnet on the door frame and to place the hall sensor on the door leaf. Opening and closing of the building door 2, 2′, 2″ changes the relative distance between the magnet and the hall sensor, resulting in a difference in the magnetic force from the magnet detected by the hall sensor. Detection of this difference in the magnetic force triggers release of a door signal by the hall sensor. With knowledge of the present invention it is obviously also possible for the man skilled in the art to arrange the door sensor outside a building door 2, 2′, 2″ or near a building door 2, 2′, 2″. Thus, the door sensor can be a movement recording device which is arranged in the door frame of the building door or in a building wall near the building door. Other embodiments of door sensors will be described more in detail in the description of the electronic door trim in connection with the FIGS. 11 to 15. It is also possible for the door sensor to be a load mat which is arranged on the floor of the storey in front of or near the building door. In that case, opening of the building door is associated with detection of a movement by the movement reporting device or with the detection of a load by the load mat. Correspondingly, closing of the building door is associated with omission of detection of a movement by the movement recording device or with omission of detection of a load by the load mat and it is also possible to combine several of the door sensors with one another and to correspondingly communicate combined door signals to the elevator control.

In the form of embodiment of the building door 2, 2′, 2″ according to FIG. 4 at least one recognition device 90, 90′, 90″ is additionally integrated in the building door 2, 2′, 2″. The recognition device 90, 90′, 90″ comprises a transmitting and receiving unit for an electromagnetic field and communicates by way of a radio frequency with at least one mobile call input device 10 provided with the user. The call input device 10 is, for example, a Radio Frequency Identification (RFID) card with at least one coil, at least one data memory and at least one processor. The radio frequency used by the transmitting and receiving unit is, for example, 125 kHz, and 13.56 MHz, 2.45 GHz, etc. The call input device 10 takes up, by way of its coil, inductive energy from the electromagnetic field of the recognition device 90, 90′, 90″ and is thus activated in terms of energy. The energy activation takes place automatically as soon as the call input device 10 is disposed in the range of the electromagnetic field from a few centimetres up to a metre. As soon as the recognition device 90, 90′, 90″ is activated in terms of energy the processor reads out an identification code which is filed in the data memory and which is transmitted by way of the coil to the recognition device 90, 90′, 90″. The energy activation of the coil input device 10 and the transmission of the identification code to the recognition device 90, 90′, 90″ are carried out contactlessly. The recognition device 90, 90′, 90″ receives the transmitted identification code by the receiving unit and electronically prepares it. For that purpose the recognition device 90, 90′, 90″ comprises at least one further data memory and at least one further processor. The transmitted identification code is recognised by the further processor in accordance with the recognition protocol. The recognised identification code is communicated to the elevator control as a user recognition signal.

Whereas in the form of embodiment of a building door 2, 2′, 2″ according to FIG. 3 only one door signal is communicated to the elevator control 4, in the form of embodiment of a building door 2, 2′, 2″ according to FIG. 4 the communication of a door signal and a user recognition signal to the elevator control 4 is carried out. On communication of only a door signal to the elevator control 4, the elevator control 4 defines the storey of the communicated door signal as start storey and actuates a start call for an elevator cage 7 on the start storey. A destination call pre-defined for the start storey is actuated by the elevator control 4. On additional communication of a user recognition signal to the elevator control 4 the elevator control 4 identifies the communicated user recognition signal. The elevator control 4 comprises for that purpose at least one user data memory and at least one computing processor. The computing processor identifies the communicated user recognition signal by a pre-defined destination call filed in the user data memory.

At least one terminal 9, 9′, 9″ is arranged in stationary position near the elevator doors 3, 3′, 3″ on each storey 1, 1′, 1″. An identical or a similar panel 9 is also arranged in the elevator cage 7. As illustrated in FIGS. 5 to 8 in detail, at least one stationary call input device 91, 91′, 91″ and at least one stationary output device 92, 92′, 92″ are arranged in the housing of the terminal 9, 9′, 9″. The terminal 9, 9′, 9″ is, for example, mounted on a building wall or elevator cage wall or stands isolated in a space in front of the elevator door 3, 3′, 3″.

In the first form of embodiment of a terminal 9, 9′, 9″ according to FIG. 5 the user actuates a destination call by the stationary call input device 91, 91′, 91″ in the form of a keyboard, in which the user presses at least one button by hand. For example, the user inputs the destination storey “20” by hand as numerical sequence “2” and “0” on the keyboard. The user receives an optical and/or acoustic confirmation of the actuated destination call on the stationary output device 92, 92′, 92″. The keyboard can also be a touch-sensitive button screen.

In the further form of embodiment of a terminal 9, 9′, 9″ according to FIGS. 6 to 8 at least one stationary recognition device 90, 90′, 90″ is arranged in the housing of the terminal 9, 9′, 9″. The recognition device 90, 90′, 90″ has already been described in the foregoing. The stationary recognition device 90, 90′, 90″ receives an identification code, which is transmitted by a call input device 10, by the receiving unit. The received identification code is recognised by a further processor of the recognition device 90, 90′, 90″ in accordance with a recognition protocol. The recognised identification code is communicated to the elevator control 4 as a user recognition signal. The elevator control 4 comprises at least one user data memory and at least one computing processor. The computing processor identifies the communicated user recognition signal with a pre-defined destination call filed in the user data memory. The elevator control 4 actuates this pre-defined destination call for the elevator cage 7 to a destination storey. The user thus contactlessly actuates a destination call by the mobile call input device 10 by way of the stationary recognition device 90, 90′, 90″. In these forms of embodiment to the terminal 9, 9′, 9″ as well the user receives on the stationary output device 92, 92′, 92″ an optical and/or acoustic confirmation of the actuated destination call.

A user can change an actuated destination call by the stationary call input device 91, 91′, 91″ and/or by the mobile call input device 10.

In the first and second forms of embodiment of a terminal 9, 9′, 9″ according to FIGS. 5 and 6 the stationary call input device 91, 91′, 92″ is a keyboard by way of which the user can change the destination call by hand. For example, the user can through keyboard actuation move a cursor over possible destination call indications and, similarly by keyboard actuation, stop the cursor over a destination call indication and thus actuate a corresponding changed destination call.

In the third form of embodiment of a terminal 9, 9′, 9″ according to FIG. 7 the stationary call input device 91, 91′, 91″ is a proximity sensor, for example an infrared sensor, which converts a movement of the user into a cursor movement over possible destination call indications on the stationary output device 92, 92′, 92″. Thus, the user can, by movement of a hand, move the cursor over possible destination call indications and, by stopping the hand, stop the cursor over a destination call indication and thus actuate a corresponding changed destination call.

In the fourth form of embodiment of a terminal 9, 9′, 9″ according to FIG. 8 the recognition device 90, 90′, 90″ converts the reception or non-reception of an identification code of the mobile call input device 10 into a cursor movement over possible destination call indications on the stationary output device 92, 92′, 92″. For example, the range of the electromagnetic field for energy activation of the mobile call input device 10 amounts to a few centimetres. If the user now holds the mobile call input device 10 in the range of the electromagnetic field the cursor then moves over possible destination call indications. However, as soon as the user holds the mobile call input device 10 out of the range of the electromagnetic field the cursor movement then stops over a possible destination call indication and actuates a corresponding changed destination call.

FIGS. 9 and 10 show a retrofitted elevator system in a building. The building has the same features as those of the description according to FIG. 1. The building has several storeys 1, 1′, 1″ and at least one building door 2, 2′, 2″ is arranged per storey 1, 1′, 1″. The building door 2, 2′, 2″ is an access door to a dwelling in a building and/or an access door to the building.

An existing elevator is arranged in the building. The existing elevator comprises, in an elevator shaft, at least one elevator cage 7 which is connected by way of at least one support means 6 with at least one counterweight 8. For movement of elevator cage 7 and counterweight 8 the support means 6 is placed in motion by at least one elevator drive 5 in friction couple. At least one user has access to the elevator cage 7 by way of at least one elevator door 3, 3′, 3″. At least one elevator door 3, 3′, 3″ is usually arranged at each storey 1, 1′, 1″. Opening and closing of the elevator doors 3, 3′, 3″ is carried out by way of at least one door drive 31, which is usually arranged at the elevator cage 7 and which can be brought into operative connection with the elevator doors 3, 3′, 3″. At least one elevator control 4 controls the elevator drive 5 and the door drive 31. So that the elevator control 4 knows when the elevator cage 7 has moved into a storey 1, 1′, 1″, at least one elevator sensor 30, 30′, 30″ detects the movement of the elevator cage 7 into the storey 1, 1′, 1″. The elevator sensor 30, 30′, 30″ communicates, for a detected movement of the elevator cage 7 into a storey 1, 1′, 1″, at least one elevator cage signal to the elevator control 4. On communication of a cage signal the elevator control 4 opens the elevator door 3, 3′, 3″ of the storey 1, 1′, 1″. The elevator sensor 30, 30′, 30″ is arranged in the elevator shaft near the elevator doors 3, 3′, 3″ and consists of, for example, a mechanical or electrical contact, which is actuated by the elevator cage 7 as soon as this is moved into a storey 1, 1′, 1″ to be flush with the storey floor.

For retrofitting the existing elevator to an elevator system, at least one door sensor 20, 20′, 20″ is installed in at least one building door 2, 2′, 2″ in a step. With knowledge of the present invention the door sensor 20, 20′, 20″ can also be installed near the building door 2, 2′, 2″. In addition the entire existing building door 2, 2′, 2″ can be replaced by a building door 2, 2′, 2″ with an integrated door sensor 20, 20′, 20″.

For retrofitting the existing elevator to an elevator system at least one control 4′ is installed in a further step. The control 4′ communicates with the door sensor 20, 20′, 20″ and the elevator control 4. The door sensor 20, 20′, 20″ detects opening of the building door 2, 2′, 2″ and communicates, for a detected opening of the building door 2, 2′, 2″, at least one door signal to the control 4′. The control 4′ defines the storey 1, 1′, 1″ of the communicated door signal as start storey and actuates a start call for the elevator cage 7 to the start storey. For example, the control 4′ is connected with at least one signal input of the elevator control 4 and actuates the start call by way of this signal input. The movement of the elevator cage 7 into the start storey is detected by the elevator sensor 30, 30′, 30″. For a detected movement of the elevator cage 7 into this start storey at least one elevator cage signal is communicated to the elevator control 4 by the elevator sensor 30, 30′, 30″. The elevator door 3, 3′, 3″ of the start storey is opened by the elevator control 4 on communication of an elevator cage signal. With knowledge of the present invention it is obviously also possible to replace the former elevator control 4 by a new elevator control 4 according to the form of embodiment of FIGS. 1 and 2, which new elevator control 4 fulfils the functions of the previous elevator control 4 and those of the control 4′.

For retrofitting the existing elevator to an elevator system at least one recognition device 90, 90′, 90″ is installed in at least one existing building door 2, 2′, 2″ in a further step. Here, too, it is applicable that with knowledge of the present invention the recognition device 90, 90′, 90″ can also be installed near the building door 2, 2′, 2″ or that the entire existing building door 2, 2′, 2″ can be replaced by an integrated recognition device 90, 90′, 90″.

The recognition device 90, 90′, 90″ identifies the user and communicates, for an identified user, at least one user recognition signal to the control 4′. The control 4′ actuates a pre-defined destination call, which is filed for the communicated user recognition signal, for the elevator cage 7 to a destination storey.

For retrofitting of the existing elevator installation to an elevator system at least one antenna 40 is installed in a further step. The door sensor 20, 20′, 20″ communicates at least one door signal by way of at least one radio network to the control 4′ and/or the recognition device 90, 90′, 90″ communicates at least one user recognition signal to the control 4′ by way of at least one radio network.

For retrofitting the existing elevator to an elevator installation at least one terminal 9, 9′, 9″ is arranged on each storey 1, 1′, 1″ in stationary position near an existing elevator door 3, 3′, 3″ and/or a terminal 9 is arranged in the elevator cage 7 in a further step. The mode of function of the terminal 9, 9′, 9″ is explained in detail in the description of FIGS. 5 to 8.

The components of the electronic door trim according to the invention and the interaction of these components are now described in more detail with reference to the block diagram shown in FIG. 15. The components that are particularly relevant for the invention and that generally are not present in a known electronic door trim (such as the PEGASYS system) are the Wireless Communication Unit, the Lock Bolt Sensor, the Inside Lever, and the Override Sensor. As an additional, optional feature, the Command Buttons may also be included in an electronic door trim according to the invention.

The Wireless Communication Unit wirelessly communicates with a Control System which sends commands to the door system and which gets reports about events at the door. The Wireless Communication Unit transmits commands and events by an encrypted wireless connection. The connection can be built by one Control System and many door systems. A User Sensor detects a user in front of the door system. This may be done by detection of a credential close to a Credential Reader or by any other technical possibility to detect a user (Infrared reflective photo sensor). The Credential Reader reads credential data which may influence the decision of an Electronic Controller. The Credential Reader reading a credential corresponds to the recoginition device 90, 90′, 90″ for the recognition of an identification code which has been previously described.

A Wakeup Circuit collects a wakeup signal from different sensors (arrowed dotted lines in the diagram of FIG. 15) to wake up the electronic. The Wakeup Circuit plays an important role to keep a minimum of energy consumption over the complete door system.

The Lock Bolt Sensor detects and represents the status of the deadbolt (locked or unlocked). The Lock Bolt Sensor may be an electromechanical contact in the embodiment of a magnet and corresponding a hall sensor, where the magnet on the retracted lockbolt magnetizes the hall sensor which triggers release of a door signal by the hall sensor. The Lock Bolt Sensor may be an electric contact which is closed for a retracted lockbolt and open for an extended lockbolt. An open electric contact triggers release of a door signal. The Override Sensor detects and represents the status of the mechanical key override (by turning a key in a mechanical locking cylinder). The Override Sensor may be an electric contact which is closed for no key in the mechanical locking cylinder and open for an inserted and turned key in the mechanical locking cylinder. An open electric contact triggers release of a door signal. If the protected door is opened by an override key, the Override Sensor will immediately forward and report this information to a monitoring and/or control unit for security reasons in order to prevent the unauthorized opening of the door.

A Clutching Mechanism for the Inside Lever and the Outside Lever of the door allows the movement of the inner and/or outer lever to be sent to the mechanical lock to open the door. The inner lever can trigger the Wakeup Circuit. A movement of the inner lever is reported to the electronics and/or a monitoring/control unit, particularly for security reasons in order to prevent the unauthorized opening of the door and/or the leaving of the protected room by an unauthorized person. The Clutching Mechanism may be a microswitch which is activated or deactivated by a movement of the inner lever. For example, an activated microswitch triggers release of a door signal.

As an optional feature, the Command Buttons may be represented by standard push buttons on the inner or outer side of the door. These buttons may initiate commands to the Electronic Controller, or commands are sent by wireless communication to the Control System, for example to initiate actions within a higher or super-ordinate communication system, e.g. initiating an alarm or calling a front door security service. For example, an activated Command Button triggers release of a door signal. It is also possible to foresee Command Buttons on the inner and outer side of the building door.

Accordingly, the invention provides an electronic door trim system which operates wireless and therefore does not require the extensive and complex cable wiring as known from prior art systems. For these reasons, the system according to the invention is operating more safely, reliable and secure and does not tend to fail. The electronic door trim system of the invention allows for the complete monitoring of a protected door, particularly with respect to opening and/or closing the door by authorized or non-authorized persons at authorized or non-authorized times. Besides, the system of the invention can determine whether a protected door after its opening is closed again, as required, or whether it stays open, for example by means of not permitted, irregular blocking means (such as a wedge pushed underneath the door).

As an addition to the invention and an embodiment thereof, FIGS. 13a to 13d show the mounting of the wireless device with an adapter to the door trim.

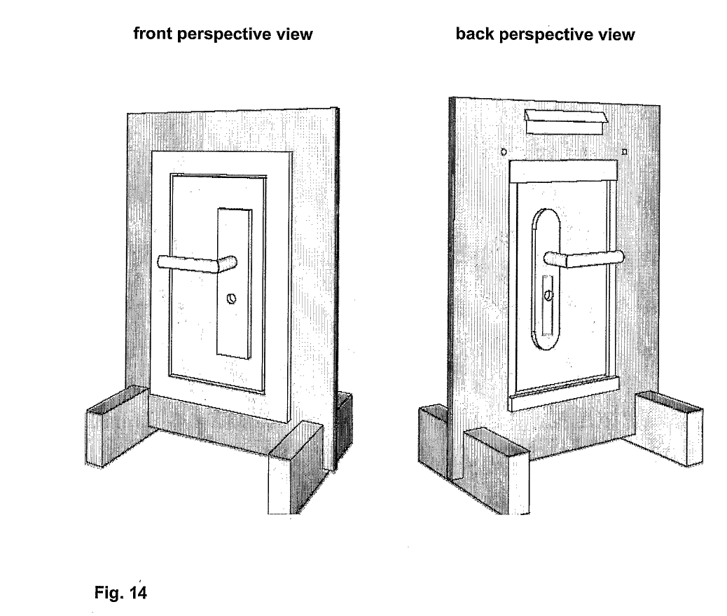

FIG. 14 shows a door model within which the wireless functions according to the invention may be utilized. Therein, the door is shown in a perspective view from the front side and from the backside.

1-25. (canceled)

26. An electronic door trim for controlling an unlocking and opening or locking and closing, respectively, of a door in a building having an elevator system, for an authorized or non-authorized access to a protected area, wherein said electronic door trim comprises:
a control system which sends commands to the door and which receives reports about events at the door;
a user sensor which detects a user in front of the door by detection of credential data, wherein the detected credential data influence a decision of an electronic controller; and
a wakeup circuit which collects a wakeup signal from sensors to wake up the electronic controller.

27. The electronic door trim according to claim 1 including:
a wireless communication unit which communicates with the control system and which transmits commands and events by an encrypted wireless connection;
a lock bolt sensor which detects and represents the locked or unlocked status of a deadbolt;
an override sensor which detects and represents the status of a mechanical override key;
an inside lever and an outside lever for the door; and
a clutching mechanism for the inside lever and the outside lever which sends the movement of the inside lever and/or the outside lever to the mechanical lock of the door to open the door.

28. The electronic door trim according to claim 26 wherein the inner lever triggers the wakeup circuit.

29. The electronic door trim according to claim 26 further comprising command buttons which initiate commands to the electronic controller or commands that are sent by wireless communication to the control system.

30. An elevator system in a building with at least two floors, at least one elevator door, and the building door having a door sensor integrated in an electronic door trim according to claim 26, comprising;
the door sensor detecting opening and/or closing of the building door and for a detected opening and/or closing of the building door communicating a door signal to an elevator control;
the elevator control defining a floor of the communicated door signal as a start floor;
the elevator control actuating a start call for an elevator car to move to the start floor;
an elevator sensor detecting movement of the elevator car into the start floor;
the elevator sensor communicating for a detected movement of the elevator car into the start floor an elevator car signal to the elevator control; and
the elevator control, upon receipt of the elevator car signal, opens the at least one elevator door of the start floor.

31. The elevator system according to claim 30 wherein the door sensor integrated in the electronic door trim is one of:
an electromechanical contact of the building door, wherein said electromechanical contact communicates a detention of a deadbolt in a lock plate and/or a release of a deadbolt from a lock plate as the door signal to an electronic controller of the building door;
a credential reader of the building door, wherein said credential reader communicates a detection of a credential as the door signal to an electronic controller of the building door;
an override sensor, wherein said override sensor communicates a status of a mechanical key override of the building door as the door signal to an electronic controller of the building door;
a lock bolt sensor, wherein said lock bolt sensor communicates a status of a deadbolt of the building door as the door signal to an electronic controller of the building door;
a clutching mechanism for an inside lever and an outside lever of the building door, wherein said clutching mechanism communicates a movement of the inside and/or outside lever as the door signal to an electronic controller of the building door;
an infrared reflective photo sensor, wherein said infrared reflective photo sensor communicates detection of a user in front of the building door as the door signal to an electronic controller of the building door; and
a command button on the inner and/or outer side of the building door, wherein said command button communicates activation of the command button as the door signal to an electronic controller of the building door.

32. The elevator system according to claim 30 wherein the door sensor communicates the door signal to at least one of:
the elevator control or the control system by a radio network;
the wakeup circuit of the building door, the wakeup circuit collects the door signal as the wakeup signal and communicates the wakeup signal to an electronic controller of the building door, and the electronic controller wakes up for the received wakeup signal; and
an electronic controller of the building door, the electronic controller communicates the door signal to a wireless communication unit of the building door, and the wireless communication unit communicates the door signal to the elevator control or the control by a radio network.
